(19) United States
(12) Patent Application Publication
(10) Pub. No.: US 2003/0156894 A1
(43) Pub. Date: Aug. 21, 2003

(54) Ball joint

(75) Inventors: Akemitsu Suzuki, Aichi (JP); Tokuji Yokoyama, Aichi (JP); Yasuhiro Kondoh, Aichi (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: MUSASHI SEIMITSU INDUSTRY CO., LTD.

(21) Appl. No.: 10/329,559

(22) Filed: Dec. 27, 2002

(30) Foreign Application Priority Data
Feb. 21, 2002 (JP) 2002-044522

(51) Int. Cl. F16D 1/12

(52) U.S. Cl. 403/134

(57) ABSTRACT

A ball joint includes a retaining ring press-fitted to a shank of a ball stud, and a boot having first and second annular beads mounted to the retaining ring and a ball socket, respectively. In the ball joint, a very small clearance left between press-fit portions of the shank and the retaining ring is filled with a sealing agent. Thus, a portion where the retaining ring is mounted to the shank of the ball stud can be simply brought into a highly reliable sealed state.

### BACKGROUND OF THE INVENTION

1. Field of the Invention

The present invention relates to a ball joint used at an oscillating portion of a suspension of an automobile, and particularly to an improvement in a ball joint comprising a ball stud, a ball socket for swingably retaining a ball-shaped head of the ball stud with a bearing interposed therebetween, a retaining ring having a cylindrical portion mounted to an outer peripheral surface of a shank and a flange protruding from an axially outer end of the cylindrical portion, and a boot having first and second annular beads mounted to the retaining ring and the ball socket and sealing an opening of the ball stud, the first mounting bead being formed with an end face seal portion and an inner periphery seal portion, which are adapted to come close contact with the cylindrical portion and the flange of the retaining ring, respectively.

2. Description of the Related Art

Such a ball joint is already known, for example, as disclosed in Japanese Patent Application Laid-open No.11-63245 (FIG. 4).

To provide a seal between the shank of the ball stud and the retaining ring mounted to the shank in the conventional ball joint, the following two measures are known:

(1) The retaining ring is press-fitted to the outer peripheral surface of the shank.

(2) A seal member is baked to an inner peripheral surface of the retaining ring to come into close contact with the outer peripheral surface of the shank.

However, the measure (1) has a disadvantage that unless the size and the surface roughness of the press-fit portions and the press-fitting load are controlled strictly, a good sealed state of the press-fit portions cannot be ensured, resulting in a lack of reliability. The measure (2) has a disadvantage that an increase in cost cannot be avoided due to the baking of the seal member to the inner peripheral surface of the retaining ring.

### SUMMARY OF THE INVENTION

Accordingly, it is an object of the present invention to provide a ball joint, wherein a portion where the retaining ring is mounted to the shank of the ball stud can be easily brought into a highly reliable sealed state, and a reduction in cost can be provided.

To achieve the above object, according to a first feature of the present invention, there is provided a ball joint comprising a ball stud, a ball socket for swingably retaining a ball-shaped head of the ball stud with a bearing interposed therebetween, a retaining ring having a cylindrical portion mounted to an outer peripheral surface of a shank and a flange protruding from an axially outer end of the cylindrical portion, and a boot having first and second annular beads mounted to the retaining ring and the ball socket, the first mounting bead being formed with an end face seal portion and an inner periphery seal portion which are adapted to come into close contact with the cylindrical portion and the flange of the retaining ring, respectively, wherein the cylindrical portion is press-fitted to the outer peripheral surface of the shank, and a clearance left between press-fit portions of the cylindrical portion and the shank is filled with a sealing agent.

The end face seal portion, the inner periphery seal portion and the flange correspond to an end face seal lip 26, an inner periphery seal lip 27 and a large flange 19b in an embodiment of the present invention which will be described hereinafter.

With the first feature, even if a very small clearance is left between the press-fit portions of the cylindrical portion of the retaining ring and the shank of the ball stud, the clearance can be filled with the sealing agent, whereby the press-fit portions can be brought into a good sealed state. Therefore, the very small clearance is permitted to be left between the press-fit portions, and the reliability of the sealability of the press-fit portions can be enhanced, while enabling increases in acceptable ranges of the size and surface roughness of the press-fit portions and a press-fitting load, and moreover, an increase in cost due to the use of the sealing agent is extremely small.

According to a second feature of the present invention, there is provided a ball joint comprising a ball stud, a ball socket for swingably retaining a ball-shaped head of the ball stud with a bearing interposed therebetween, a retaining ring having a cylindrical portion mounted to an outer peripheral surface of a shank and a flange protruding from axially outer end of the cylindrical portion, and a boot having first and second annular beads mounted to the retaining ring and the ball socket, the first mounting bead being formed with an end face seal portion and an inner periphery seal portion which are adapted to come into close contact with the cylindrical portion and the flange of the retaining ring, respectively, wherein the cylindrical portion is press-fitted to the outer peripheral surface of the shank, and a very small annular recess is defined between an inner peripheral surface of the flange and the outer peripheral surface of the shank and filled with a sealing agent.

With the second feature, even if a very small clearance is left between press-fit portions of the cylindrical portion of the retaining ring and the shank of the ball stud, the press-fit portions can be brought into a good sealed state by filling the small annular recess with the sealing agent. Therefore, also in this case, the very small clearance is permitted to be left between the press-fit portions, and the reliability of the sealability of the press-fit portions can be enhanced, while enabling increases in acceptable ranges of the size and surface roughness of the press-fit portions and a press-fitting load, and moreover, an increase in cost due to the use of the sealing agent is extremely small.

According to a third feature of the present invention, in addition to the second feature, a portion of the sealing agent is caused to penetrate from the small annular recess into a clearance left between press-fit portions of the cylindrical portion and the shank.

With the third feature, the reliability of the sealability of the press-fit portions can be further enhanced.

According to a fourth feature of the present invention, in addition to the second or third feature, the small annular recess is defined between the outer peripheral surface of the shank and a small curved face formed outside a folded portion between the cylindrical portion and the flange, when the retaining ring is formed by pressing.

With the fourth feature, it is unnecessary to conduct a special working or processing to the shank and the retaining ring for forming the small curved face, which can contribute to a reduction in cost.

According to a fifth feature of the present invention, in addition to the second or third feature, an annular step between the press-fit portion of the shank to which the cylindrical portion is press-fitted and a smaller-diameter portion adjoining such press-fit portion is brought from the flange toward the cylindrical portion, thereby defining the small annular recess between the inner peripheral surface of the flange and the outer peripheral surface of the shank.

Also with the fifth feature, it is unnecessary to conduct a special working or processing to the shank and the retaining ring for forming the small curved face, which can contribute to a reduction in cost.

The above and other objects, features and advantages of the invention will become apparent from the following description of the preferred embodiment taken in conjunction with the accompanying drawings.

### BRIEF DESCRIPTION OF THE DRAWINGS

FIGS. 1A and 1B are side views of a section of a suspension of an automobile, which is provided with a ball joint of the present invention;

FIG. 2 is a vertical sectional view of the ball joint shown in FIG. 1;

FIG. 3 is an enlarged view of a portion indicated by 3 in FIG. 2; and

FIG. 4 is a view similar to FIG. 3 for explaining the operation.

### DESCRIPTION OF THE PREFERRED EMBODIMENT

A preferred embodiment of the present invention will now be described with reference to the accompanying drawings.

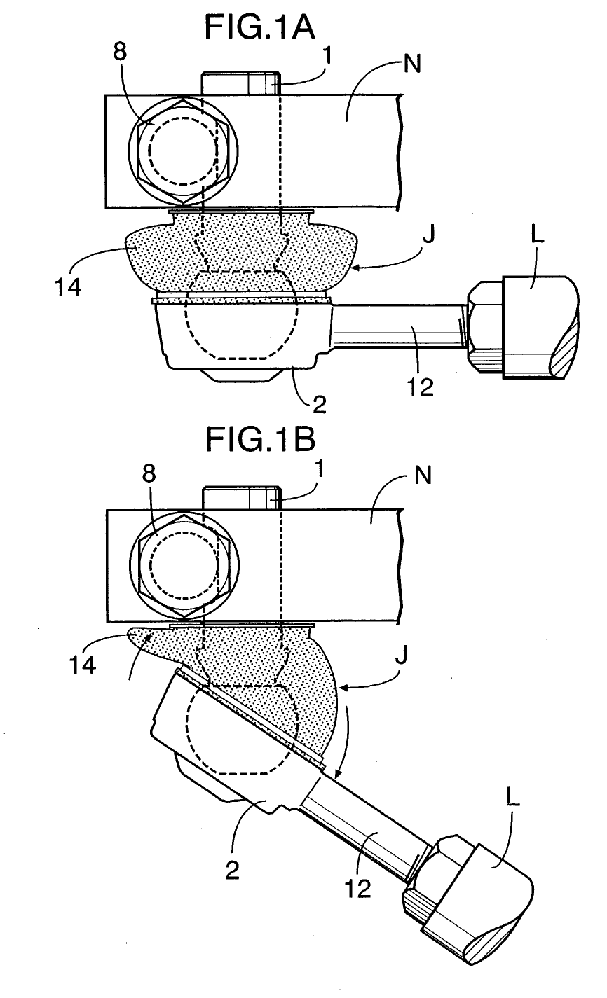

Referring first to FIGS. 1A and 1B, a link L and a knuckle arm N in a suspension of an automobile are connected to each other through a ball joint J according to this embodiment, so that they can be swung relative to each other in response to a vertical movement or turning of a wheel, as shown in FIGS. 1A and 1B.

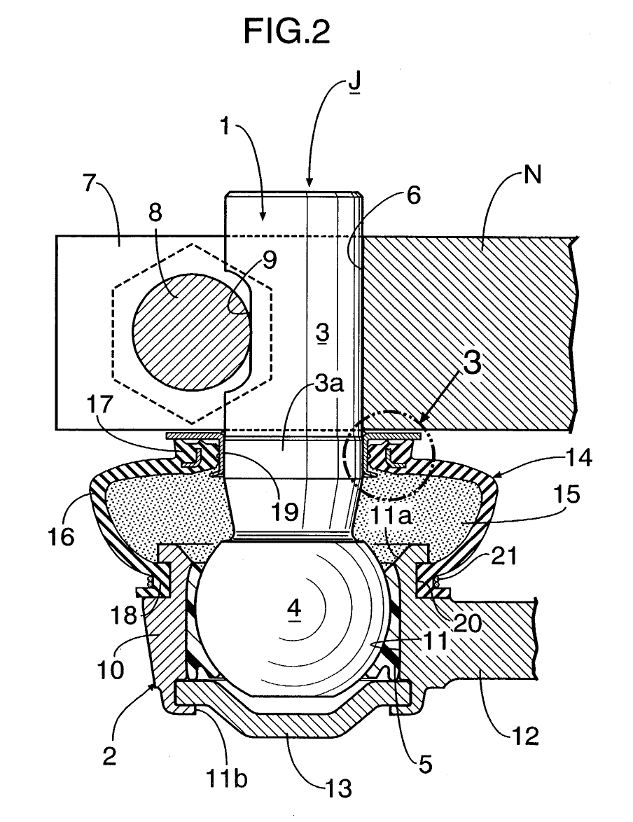

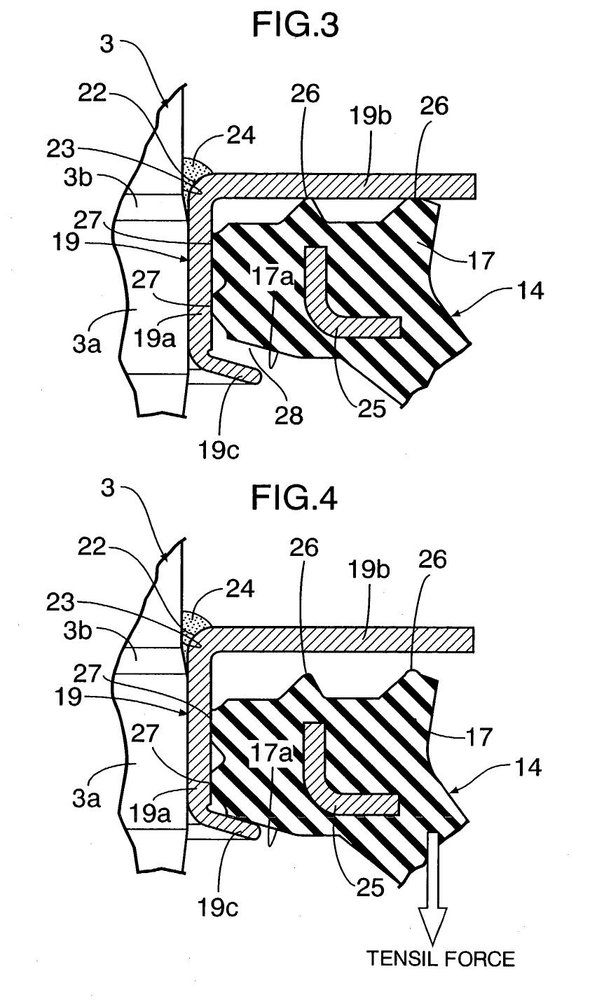

As shown in FIGS. 2 and 3, the ball joint J includes a ball stud 1 having a ball-shaped head 4 integrally formed at one end of a shank 3, and a ball socket 2 for retaining the ball-shaped head 4 with a bearing ring 5 interposed therebetween. Then ball stud 1 is fitted in a connecting bore 6 having a slit 7 in the knuckle arm N, and is connected to the knuckle N by tightening the slit 7 by a bolt 8. In this case, one side of the bolt 8 serves as a detent portion for the shank 3 by engagement in a notch 9 defined in one side of the shank 3.

The ball socket 2 comprises a socket body 10 formed with a housing 11 which accommodates the ball-shaped head 4 along with the bearing 5, a connecting arm 12 protruding from one side of the socket body 10, and a cap 13 for closing an opening 11b in the housing 11 opposite from an opening 11a from which the shank 3 of the ball socket 2 protrudes. The connecting arm 12 is connected to the link L.

A boot 14 is spread between the shank 3 and the socket body 10 to seal the opening 11a in the housing 11, and an appropriate amount of grease 15 for lubricating the periphery of the ball-shaped head is filled within the boot 14.

The boot 14 is made of an elastic material such as rubber and comprises a pouch-shaped boot body 16, and first and second annular mounting beads 17 and 18 integrally formed at opposite ends of the boot body 16. The second mounting bead 18 has a diameter larger than that of the first mounting bead 17. The first mounting bead 17 is mounted to a retaining ring 19 press-fitted and coupled to a shank 3 of the ball stud 1, and the second mounting bead 18 is mounted, as usual in the prior art, in an annular groove 20 defined in an outer periphery of a side end of the opening 11a in the socket body 10, and is tightened by a set ring 21.

The retaining ring 19 is made of a steel plate and comprises a cylindrical portion 19a, and a pair of large and small flanges 19b and 19c protruding radially from axially opposite ends of the cylindrical portion 19a, respectively. The cylindrical portion 19a is press-fitted and coupled to a press-fit portion 3a of the shank 3 of the ball stud 1, the press-fit portion 3a being exposed from the knuckle arm N toward the ball-shaped head 4 and having a diameter slightly larger than that of another portion, while the large flange 19b is opposed to a side of the knuckle arm N. In this case, a small annular recess 23 is defined between the large flange 19b and the shank 3.

More specifically, the small annular recess 23 is defined between an outer peripheral surface of the shank 3 and a small curved face 22 formed outside a folded portion between the cylindrical portion 19a and the large flange 19b, when the retaining ring 19 is formed by pressing. The small annular recess 23 is also defined between an inner peripheral surface of the large flange 19b and the outer peripheral surface of the shank 3 by bringing an annular step 3b between the press-fit portion 3a of the shank 3 and a smaller-diameter portion provided above the press-fit portion 3a from the large flange 19b toward the cylindrical portion 19a.

A liquid sealing agent 24 is applied to the small annular recess 23. Thus, the sealing agent 24 fills the small annular recess 23 and permeates into a very small clearance left between press-fit faces of the shank 3 and the cylindrical portion 19a by capillary action, and is then solidified.

On the other hand, an annular reinforcing ring 25 is embedded within the first mounting bead 17, as shown in FIG. 3. A pair of large and small end face seal lips 26, 26 arranged concentrically are formed on an axially outer end face of the first mounting bead 17, and a pair of inner periphery seal lips 27, 27 arranged axially are formed on an inner peripheral surface of the first mounting bead 17. The first mounting bead 17 is mounted to the retaining ring 19 in such a manner that the end face seal lips 26, 26 are in close contact with an inner side face of the large flange 19b and the inner periphery seal lips 27, 27 are in close contact with an outer peripheral surface of the cylindrical portion 19a. The close contact force of the end face seal lips 26, 26 with the large flange 19b relies on an axial stretching force of the boot body 16, and the close contact force of the inner periphery seal lips 27, 27 with the cylindrical portion 19a relies on a radial interference provided to the first mounting bead 17.

A predetermined clearance 28 is provided between the small flange 19c and the inner end face 17a of the first mounting bead 17 opposed to the small flange 19c, and adapted to permit the movement of the first mounting bead 17 toward the small flange 19c, when the end face seal lips 26, 26 are in close contact with the large flange 19b. In this case, both the small flange 19c and the inner end face 17a of the first mounting bead 17 opposed to the small flange 19c are formed into tapered shapes such that they are inclined toward the ball-shaped head 4 in a radially outward direction.

To form the small flange 19c of the retaining ring 19, in the embodiment, the first mounting bead 17 is first mounted to the cylindrical portion 19a, and an open end of a particular cylindrical portion 19a previously set at a tip end of the cylindrical portion 19a is then pressed from the side of the second mounting bead 18 by an expanding jig so that the open end is expanded. In this manner, the small flange 19c is formed.

The operation of this embodiment will be described below.

In the boot 14 of the ball joint J, the end face seal lips 26, 26 of the first mounting bead 17 are usually retained in close contact with the large flange 19b of the retaining ring 19 by the axial stretching force of the boot body 16 itself, and even when the ball stud 1 and the ball socket 2 are swung relative to each other, as shown in FIGS. 1A and 1B, the boot body 16 is only deformed resiliently, and the close contact of the end face seal lips 26, 26 of the first mounting bead 17 with the large flange 19b is retained. Therefore, it is possible to prevent the entrance of water, mud and sand into the boot 14 by a sealing function of the end face seal lips 26, 26 to the large flange 19b and a sealing function of the inner periphery seal lips 27, 27 to the cylindrical portion 19a.

The small annular recess 23 defined between the inner periphery of the large flange 19b of the retaining ring 19 and the shank 3 of the ball stud 1 is filled with the sealing agent 24 applied thereto, and a portion of the sealing agent also penetrates into the very small clearance left between the press-fit portions of the cylindrical portion 19a of the retaining ring 19 and the shank 3 of the ball stud 1 to fill the very small clearance. Therefore, it is possible to reliably prevent the entrance of water, mud and sand from the press-fit portions into the boot 14. Therefore, the very small clearance is permitted to remain between the press-fit portions of the shank 3 and the retaining ring 19 and hence, the reliability of the sealability of the press-fit portions can be enhanced, while enabling increases in acceptable ranges of the size and surface roughness of the press-fit portions and a press-fitting load, and moreover, an increase in cost due to the use of the sealing agent is extremely small.

The small annular recess 23 is defined between the outer peripheral surface of the shank 3 and the small curved face 22 formed outside the folded portion between the cylindrical portion 19a and the large flange 19b, when the retaining ring 19 is formed by pressing, and hence, it is unnecessary to conduct a special working or processing to the shank 3 and the retaining ring 19 for forming the small curved face 22, which can contribute to a reduction in cost.

The small annular recess 23 is defined between the inner peripheral surface of the large flange 19b and the outer peripheral surface of the shank 3 by bringing the annular step 3b between the press-fit portion 3a of the shank 3 and the smaller-diameter portion provided above the press-fit portion 3a from the large flange 19b toward the cylindrical portion 19a and hence, also in this case, it is unnecessary to conduct a special working or processing to the shank 3 and the retaining ring 19 for forming the small curved face 22, which can contribute to a reduction in cost.

If mud or snow deposited to the outer peripheral surface of the boot 14 is frozen during parking of the automobile in a cold district, the boot 14 is hardened. If the automobile is started in such a state and the ball stud 1 and the ball socket 2 are swung relative to each other with the starting of the automobile, the first mounting bead 17 is pulled toward the ball-shaped head 4 in a side where the tensile force of the boot is applied. However, because the clearance 28 is provided between the inner end face 17a of the first mounting bead 17 and the small flange 19c of the retaining ring 19, the first mounting bead 17 is moved toward the small flange 19c, while the inner periphery seal lips 27, 27 are slid on the cylindrical portion 19a of the retaining ring 19. Therefore, it is possible to avoid the generation of an excessive stress on the first mounting bead 17 and the boot body 16 to ensure the durability of the boot 14.

If the mud or snow in the frozen state is peeled off from the boot 14 by the slight flexure of the boot body 16 during such movement of the first mounting bead 17, the boot 14 exhibits an intrinsic stretching force to push back the first mounting bead 17 toward the large flange 19b, whereby the end face seal lips 26, 26 can be retained in close contact with large flange 19b.

If the movement of the first mounting bead 17 toward the small flange 19c were excessive, the separation of the first mounting bead 17 from the retaining ring 19 is inhibited by abutment of the inner end face 17a of the first mounting bead 17 against the small flange 19c, as shown in FIG. 4. In this case, because the inner end face 17a and the small flange 19c abutting against each other are of such tapered shapes that they are inclined toward the ball-shaped head 4 in the radially outward direction, as described above, a shock upon the abutment can be dispersed radially outwards, whereby the damage to the first mounting bead 17 due to the abutment shock can be prevented. The formation of the inner end face 17a and the small flange 19c into tapered shapes such that they are inclined toward the ball-shaped head 4 in the radially outward direction, ensures that the predetermined clearance 28 can be provided between the inner end face 17a and the small flange 19c, thereby avoiding an increase in size of the ball joint J.

Although the embodiments of the present invention have been described in detail, it will be understood that various modifications in design may be made without departing from the spirit and scope of the invention defined in the claims. For example, to seal the press-fit portions of the shank 3 of the ball stud 1 and the cylindrical portion 19a of the retaining ring 19, the entire periphery of the cylindrical portion 19a may be welded to the shank 3 by a laser beam, in place of the application of the sealing agent 24.

What is claimed is:

1. A ball joint comprising a ball stud, a ball socket for swingably retaining a ball-shaped head of said ball stud with a bearing interposed therebetween, a retaining ring having a cylindrical portion mounted to an outer peripheral surface of a shank and a flange protruding from an axially outer end of said cylindrical portion, and a boot having first and second annular beads mounted to said retaining ring and said ball socket, said first mounting bead being formed with an end face seal portion and an inner periphery seal portion which are adapted to come into close contact with said cylindrical portion and said flange of said retaining ring, respectively,
wherein said cylindrical portion is press-fitted to the outer peripheral surface of said shank, and a clearance left between press-fit portions of said cylindrical portion and said shank is filled with a sealing agent.

2. A ball joint comprising a ball stud, a ball socket for swingably retaining a ball-shaped head of said ball stud with a bearing interposed therebetween, a retaining ring having a cylindrical portion mounted to an outer peripheral surface of a shank and a flange protruding from an axially outer end of said cylindrical portion, and a boot having first and second annular beads mounted to said retaining ring and said ball socket, said first mounting bead being formed with an end face seal portion and an inner periphery seal portion which are adapted to come into close contact with said cylindrical portion and said flange of said retaining ring, respectively,
wherein said cylindrical portion is press-fitted to the outer peripheral surface of said shank, and a very small annular recess is defined between an inner peripheral surface of said flange and the outer peripheral surface of said shank and filled with a sealing agent.

3. A ball joint according to claim 2, wherein a portion of said sealing agent is caused to penetrate from said small annular recess into a clearance left between press-fit portions of said cylindrical portion and said shank.

4. A ball joint according to claim 2 or 3, wherein said small annular recess is defined between the outer peripheral surface of said shank and a small curved face formed outside a folded portion between said cylindrical portion and said flange, when said retaining ring is formed by pressing.

5. A ball joint according to claim 2 or 3, wherein an annular step between the press-fit portion of said shank to which said cylindrical portion is press-fitted and a smaller-diameter portion adjoining said press-fit portion is brought from said flange toward said cylindrical portion, thereby defining said small annular recess between the inner peripheral surface of said flange and the outer peripheral surface of said shank.
